(19) United States
(12) Patent Application Publication
(10) Pub. No.: US 2018/0255714 A1
(43) Pub. Date: Sep. 13, 2018

(54) SIMULATED STONE LANDSCAPE EDGING

(71) Applicant: EZ CONCEPTS LLC, Rowlett, TX (US)

(72) Inventors: Dan Thomas Brinner, Rockwall, TX (US); Carl Dennis Lynch, Dallas, TX (US)

(73) Assignee: EZ CONCEPTS LLC, Rowlett, TX (US)

(21) Appl. No.: 15/981,787

(22) Filed: May 16, 2018

Related U.S. Application Data
(63) Continuation-in-part of application No. 14/713,784, filed on May 15, 2015, now Pat. No. 9,974,240.
(60) Provisional application No. 62/102,537, filed on Jan. 12, 2015.

(51) Int. Cl. A01G 9/28; B28B 7/00

(52) U.S. Cl. CPC A01G 9/28; B28B 7/0097

(57) ABSTRACT

A method of manufacturing a landscape edging apparatus is disclosed. Here, the method can include providing a pre-fabricated mold having a simulated masonry or stone configuration, positioning a plurality of tubular members onto the mold, and disposing an oil-based material into the mold. The method can further include disposing a first layer of a first polymer-based material into the mold, disposing one or more of a rock, grout, or sand-based material into the mold, and disposing a second layer of a second polymer-based material into the mold. The method can then further include the steps of curing the first and second layers within the mold into the landscape edging apparatus.

### CROSS-REFERENCE TO RELATED APPLICATION

This application is a continuation-in-part of U.S. Non-Provisional application Ser. No. 14/713,784 filed on May 15, 2015, which is incorporated herein by reference, which claims the benefit of U.S. Provisional Application No. 62/102,537 filed on Jan. 12, 2015, which is incorporated herein by reference in its entirety.

### BACKGROUND

This section is intended to introduce the reader to aspects of art that may be related to various aspects of the present disclosure described herein, which are described and/or claimed below. This discussion is believed to be helpful in providing the reader with background information to facilitate a better understanding of the various aspects of the disclosure described herein. Accordingly, it should be understood that these statements are to be read in this light, and not as admissions of prior art.

Gardeners, landscapers and homeowners frequently use border or edging material such as fences, logs, railroad ties, bricks, concrete blocks and the like to provide a decorative edge for a landscape or garden. Such border or edging material is also frequently employed to physically separate landscape, garden and other areas from one another.

Plastic landscape edging is now commonly used to divide and separate different landscape areas to preclude material in one area from spilling over into an adjacent area, and to prevent grass, flowers or the like contained in one area from growing in an adjoining area. For example, plastic edging is typically used to divide grass landscape areas from adjoining garden areas, and helps prevent grass from taking root in adjoining garden areas. Plastic edging also helps prevent garden bedding material from spilling onto the adjoining landscape area.

In the past, landscape edging has been formed from lengths of wood, corrugated metal strips, plastic, cement blocks and poured concrete. Wood is subject to rot and insect attack and decays over time. Wood landscape timbers must therefore be replaced rather frequently. Further, ungalvanized metal bands oxidize and rust, and tend to become bent and misshapen over time. Concrete and stone blocks are inflexible, difficult to install and generally heavy. Poured concrete is expensive, difficult or impossible to modify once poured and set, and difficult and time-consuming to install.

Further, the plastic or metal edging available in the market does not provide any decorative or visual appeal. Further, current edging material does now allow a user to simply install the edging material in an efficient and effective manner without requiring additional tools or more than one person or the services of professional landscape contractors.

Hence, what is needed is an edging device that is simple to use, easy to install, weatherproof, durable, lightweight, visually appealing, and cost-effective.

### BRIEF SUMMARY

In particular, in one aspect of the present disclosure described herein, a method, system, and apparatus are provided for simulated stone or masonry edging apparatus that is simple to install and remove, durable, visually appealing, lightweight, and cost-effective to manufacture.

In another aspect of the present disclosure described herein, a landscape edging apparatus is provided including one or more guides, a first flexible material having a first side and a second side, wherein the first side includes a textured surface, wherein the second side further comprises one or more receiving members, and wherein the receiving members are configured to receive the guides. In addition, the second side can further include a first receiving member and a second receiving member, wherein the first receiving member has a length longer than the second receiving member. Further, the receiving members can have a tubular configuration. In addition, a second flexible material can be coupled to the first flexible material. The first flexible material can include a first receiving member and the second flexible material can include a second receiving member. Here, the first receiving member can be axially aligned with the second receiving member for receiving at least one guide disposed through both the first and second receiving members. Here, the guide can have a J-hook configuration. Further, the textured surface can be one or more of: stone, brick, masonry, and wood.

In another aspect of the present disclosure described herein, a method of assembling a landscape edging apparatus is provided. The method can include positioning a first flexible material having a textured outer surface in an upright configuration, wherein the first material further comprises a first receiving member. The method can further include positioning a second flexible material having a textured outer surface in an upright configuration, wherein the second material further comprises a second receiving member. In addition, the method can include coupling a first end of the first material to a second end of the second material, inserting a guide through the first receiving member on the first end through a second receiving member on the second end, and wherein the guide is further inserted into the earth, thereby securing the first and second flexible materials. In addition, the first end and second end can further include a dovetail coupling. In addition, the first and second flexible materials can be further assembled in a closed loop configuration. Here, the guides can have a J-hook configuration. In addition, the first end of the first material can be stacked on top of the second end of the second material. Further, the first and second receiving members can have a cylindrical tubular configuration.

In another aspect of the present disclosure described herein, a method of manufacturing a landscaping edging apparatus is disclosed. Here, the method can include providing a pre-fabricated mold having a simulated masonry or stone configuration, positioning a plurality of tubular members onto the mold, and disposing an oil-based material into the mold. The method can further include disposing a first layer of a first polymer-based material into the mold, disposing one or more of a rock, grout, or sand-based material into the mold; and disposing a second layer of a second polymer-based material into the mold. The method can include curing the first and second layers within the mold. In addition, the step of disposing the first layer can further include spraying the first layer of the first polymer-based material into the mold. Further, the step of disposing the second layer can further include pouring the second layer of the second polymer-based material into the mold. The first polymer-based material can include a different composition from the second polymer-based material, or the first polymer-based material can include substantially the same composition of the second polymer-based material. Further, the rock, grout, or sand-based material can be evenly or uniformly distributed into the mold. In addition, the rock, grout, or sand-based material can further include 1% to 30% wt., or from 1% to 90% wt. of the landscaping edging apparatus. The method can also include color or a coloring agent into the mold. In addition, the second layer can substantially or completely cover the tubular members.

In another aspect of the present disclosure described herein, another method of manufacturing a landscaping edging apparatus is disclosed. Here, the method can include providing a mold having a simulated masonry or stone texture, dispersing a first material comprised of a first polymer or resin substance onto the mold, dispersing a second material comprised of a grout-based substance onto the first layer, and placing one or more channel guide members onto the first material, wherein the receiving members adhere to the first material. The method can further include dispersing a third material comprised of a second polymer or resin substance onto the mold. In addition, the method can include curing the first, second, and third material, wherein a duration for the curing can be from about one minute up to three minutes. Further, the dispensing the first material can further include spraying the first material of the polymer substance into the mold. In addition, the dispensing the second material can include distributing the grout substantially evenly or uniformly over the first material. The method can further include dispensing an oil-based substance onto the mold. In addition, the method can include dispensing a coloring agent onto the mold. Further, the grout-based material can include one or more of: pulverized stone or rock, clay, bentonite grout, cement based grout, sand based grout, polymer based grout, Acrylamide grout, N-Methylolacrylamide grout, acrylate grouts, polyurethanes grouts, hydrophilic grouts, hydrophobic grouts, ultrafine (or microfine) cement grout, epoxy grouts, and archeological grout.

The above summary is not intended to describe each and every disclosed embodiment or every implementation of the disclosure. The Description that follows more particularly exemplifies the various illustrative embodiments.

### BRIEF DESCRIPTION OF THE DRAWINGS

The following description should be read with reference to the drawings, in which like elements in different drawings are numbered in like fashion. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1 illustrates a front view of an edging apparatus according to one non-limiting embodiment of the present disclosure described herein.

FIG. 2A illustrates a rear view of the edging apparatus of the present disclosure described herein, further illustrating a plurality of stakes, locking, or guide members.

FIG. 2B illustrates a rear view of another non-limiting embodiment for the edging apparatus of the present disclosure described herein.

FIG. 2C illustrates another embodiment for the stakes or guide members having a flat-top configuration.

FIG. 3A illustrates a top view of the edging apparatus of the present disclosure described herein, illustrating one embodiment of cylindrical or circular female guide receiving channels or tubes.

FIG. 4A illustrates a top view of the edging apparatus of the present disclosure described herein, illustrating one embodiment of triangular shaped female guide receiving channels or tubes.

FIG. 5A illustrates a top view of the edging apparatus of the present disclosure described herein, illustrating one embodiment of square shaped female guide receiving channels or tubes.

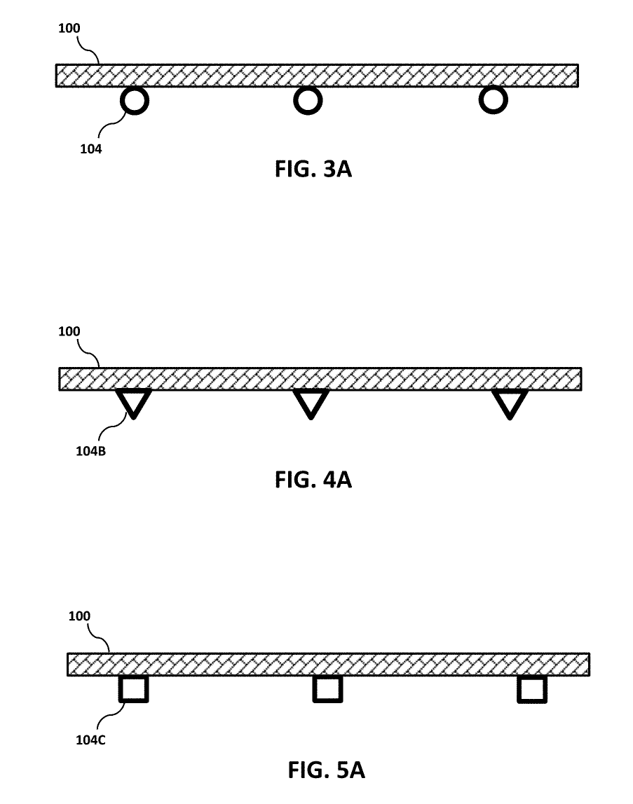

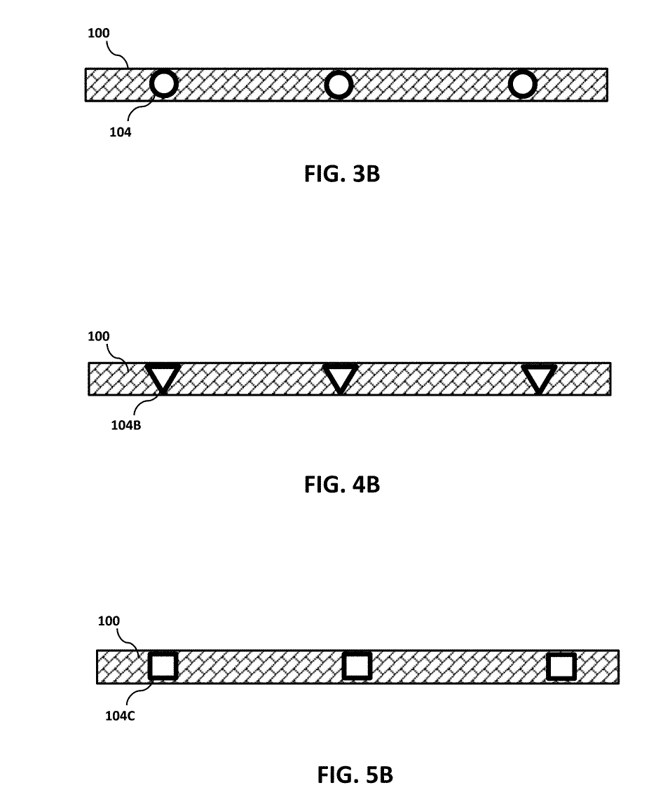

FIG. 3B illustrates a top view of the edging apparatus of the present disclosure described herein, illustrating another embodiment of cylindrical or circular female guide receiving channels or tubes.

FIG. 4B illustrates a top view of the edging apparatus of the present disclosure described herein, illustrating another embodiment of triangular shaped female guide receiving channels or tubes.

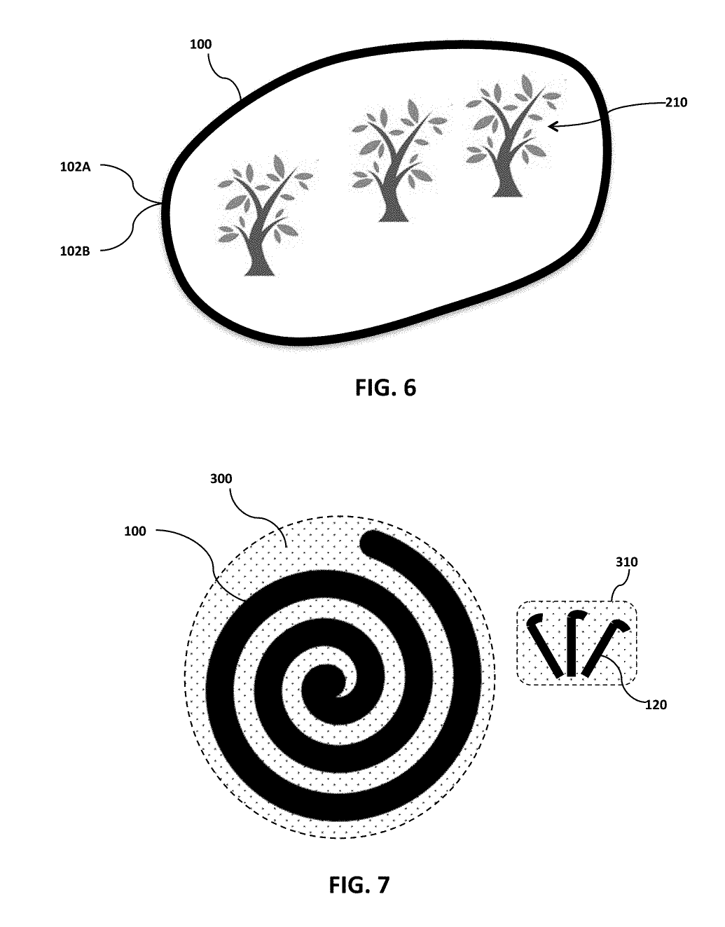

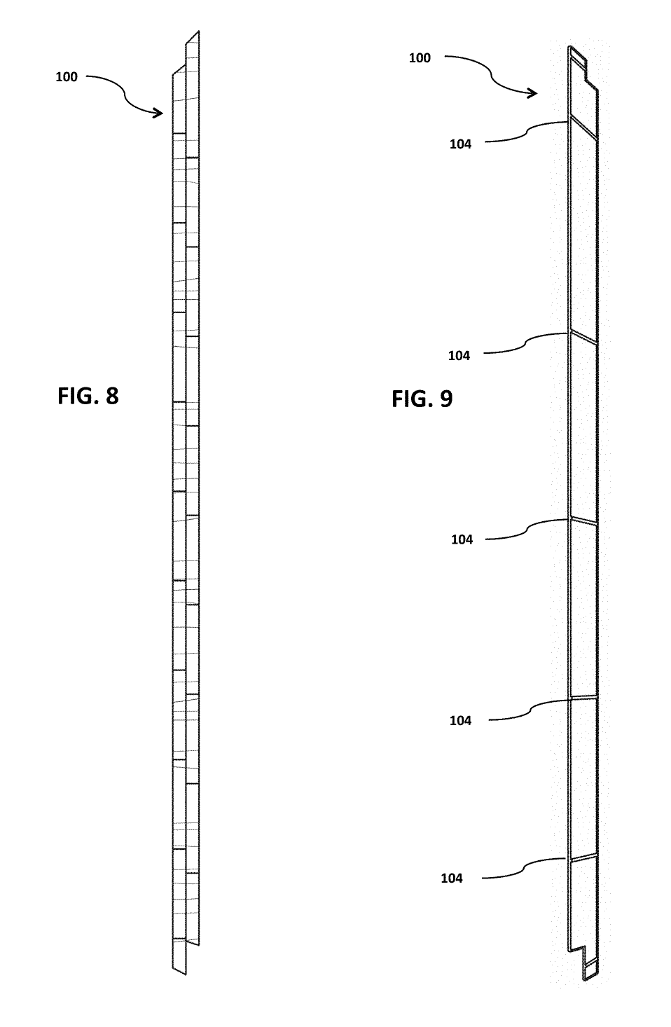

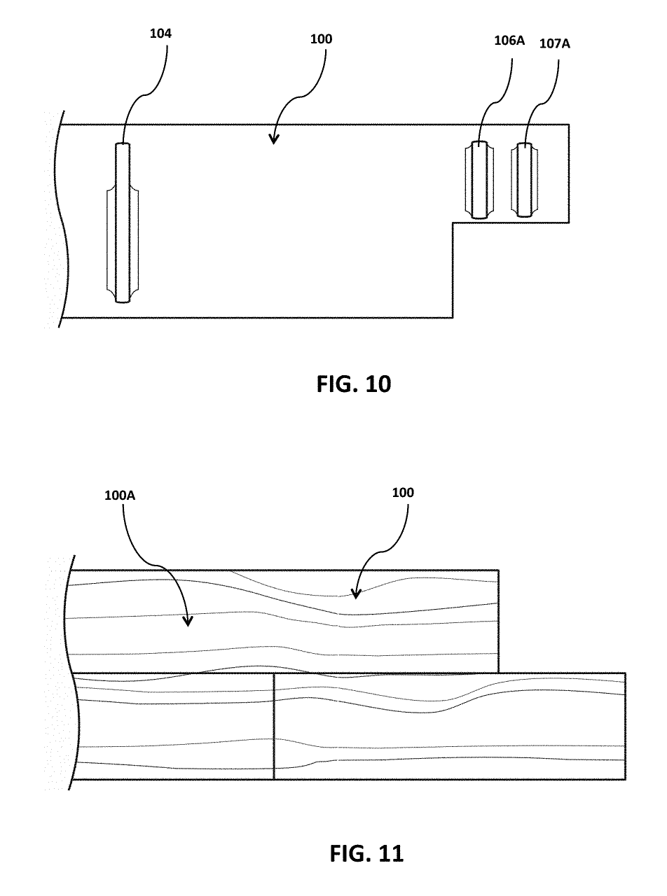

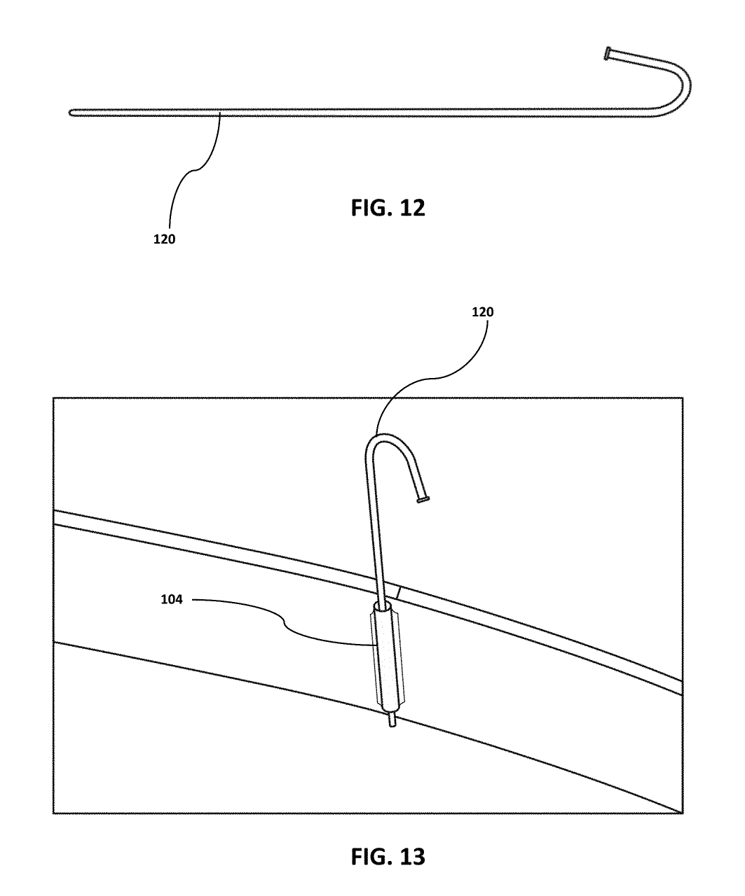

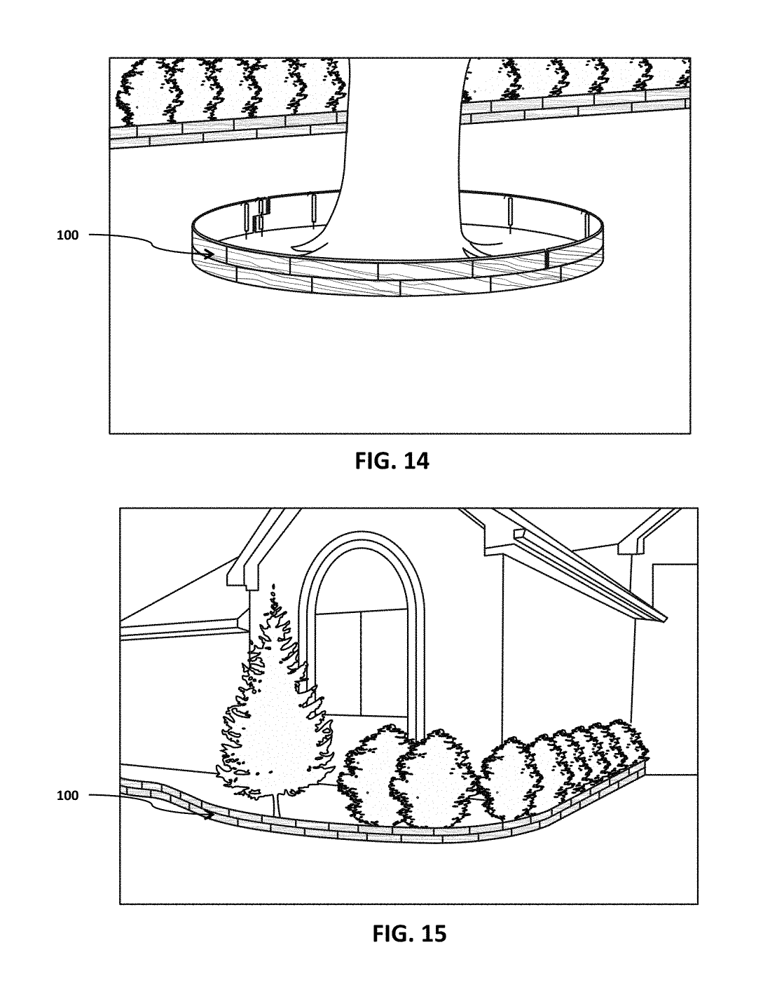

FIG. 5B illustrates a top view of the edging apparatus of the present disclosure described herein, illustrating another embodiment of square shaped female guide receiving channels or tubes.

FIG. 6 illustrates an aerial view of the edging apparatus, as assembled, enclosing a garden or landscaping in a closed loop configuration.

FIG. 7 illustrates a top view of the edging apparatus wound and wrapped in packaging, and the guides shown further packaged.

FIG. 8 illustrates a front view of the edging apparatus further illustrating a simulated stone or brick textured surface.

FIG. 9 illustrates a perspective rear view of the edging apparatus having a smooth surface.

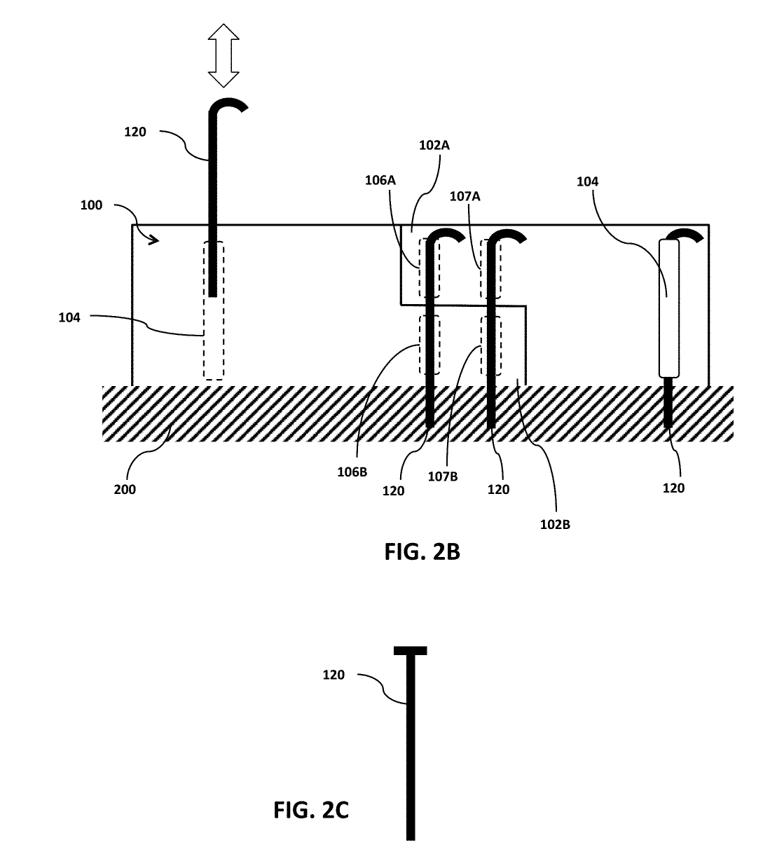

FIG. 10 illustrates a close-up rear view of the edging apparatus with the embodiment of FIG. 2B.

FIG. 11 illustrates a close-up front view of the edging apparatus further illustrating a simulated stone or brick surface.

FIG. 12 illustrates a top view of the J-hook guide or locking member of the present disclosure described herein.

FIG. 13 illustrates a perspective rear view of the guide or locking member being guided through the female guide-receiving member.

FIG. 14 illustrates a perspective view of the edging apparatus as assembled enclosing a garden or landscaping area in a closed loop configuration.

FIG. 15 illustrates a perspective view of the edging apparatus as assembled enclosing a garden or landscaping area in an open loop configuration.

### DETAILED DESCRIPTION

In the Brief Summary of the present disclosure above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The embodiments set forth below represent the necessary information to enable those skilled in the art to practice the invention and illustrate the best mode of practicing the invention. In addition, the invention does not require that all the advantageous features and all the advantages need to be incorporated into every embodiment of the invention.

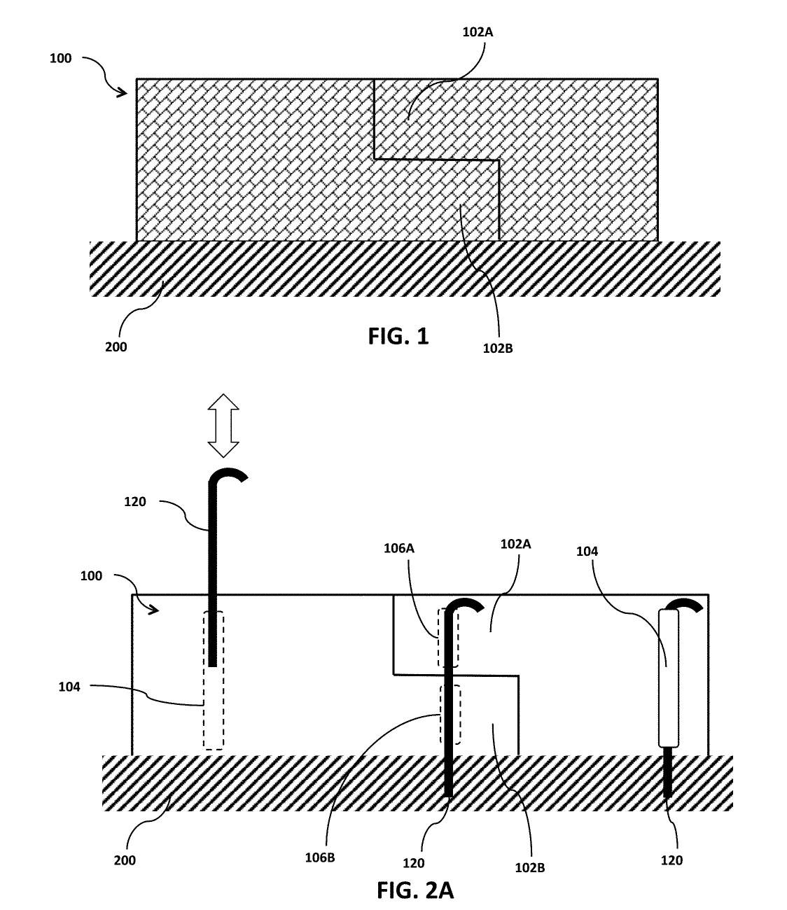

Referring now to FIG. 1, a partial front view or exterior of the edging apparatus 100 is shown wherein ends 102A and 102B are shown interlocking or joined together by dovetail. For example, in one embodiment, the apparatus 100 can be one piece (FIGS. 8-9) joined together at ends 102A and 102B. Alternatively, the edging apparatus 100 can be a plurality of modular units, modules, or apparatuses 100 joined and coupled together to form an integral unit of a plurality of edging apparatuses 100. For example, end 102A can be one unit and end 102B can be a separate unit. Here, the exterior or outer side of the edging apparatus 100 can have a variety of simulated stone, masonry, brick, concrete, or wood siding or textured surface (FIG. 11, see 100A). It is contemplated within the scope of the invention that any of the sides (interior, exterior, or top and bottom surface areas) of the edging apparatus may have a simulated or faux masonry surface or texture. In one embodiment, edging apparatus 100 can be approximately four (4) feet long, approximately six (6) inches in height and having an approximate thickness of 80 mm. However, it is contemplated within the scope of the invention that edging apparatus 100 may also have a length from one (1) feet up to 100 feet, height from two (2) inches up to ten (10) feet, and width or thickness of up to 36 inches, or any other size or dimension deemed suitable for the particular application.

Referring now to FIG. 2A, a partial rear view or interior of the edging apparatus 100 is shown wherein ends 102A and 102B are joined together. More specifically, the edging apparatus comprises a plurality of stakes, locking members or guide members 120 that secure the apparatus 100 to the earth 200. More specifically, apparatus 100 includes a plurality of integrated guide or stake receiving channels, holes, or tubes 104 that receive members 120 there-through. Here, a user can insert guides 120 through channels or tubes 104 (and also 106A-106B) wherein guides 120 are further pushed or forced downward thereby penetrating earth 200 and securely coupling or fastening the apparatus 100 to the earth. Alternatively, the members 120 can be removed by pulling them via their J-hook or top head and un-coupling the apparatus 100 from the earth. Here, the insertion of member 120 through integrated stake or guide receiving members, tubes, or channels 106A and 106B allow ends 102A and 102B to also be securely joined together, thereby providing a visually seamless coupling of the ends 102A and 102B when apparatus 100 is viewed from the exterior or outer surface. Further, FIG. 2B illustrates another embodiment for apparatus 100 having additional stake or guide receiving members tubes, or channels 107A and 107B. Here, receiving members 107A and 107B also receive guides 120 therein in addition to receiving members 106A and 106B also receiving guides 120 therein, thereby providing additional stability support and a more secure connection between ends 102A and 102B. Here, guides 120 can be approximately eleven (11) inches in height and be made of galvanized steel or aluminum. However, it is contemplated within the scope of the invention that the guides or stakes 120 may also be anywhere from two (2) inches up to 10 feet in length. Here, tubes 104, 106A-106B, 107A-107B may also operate as a mold for creating channels, holes, or apertures within edging 100 at the time of manufacture, such that the channels, holes, or apertures can operate as receiving members. Further, receiving members, tubes or channels 104, 106A-106B, 107A-107B may either be positioned as shown with respect to FIGS. 3A-5A or FIG. 3B-5B.

FIGS. 3A-5B illustrate top views for various embodiments for configurations of receiving members 104, 104B, 104C, wherein receiving members 106A-106B and 107A-107B can also have similar cross-section configurations as of 104, 104B, and 104C. More specifically, guide or stake receiving members 104 can be a cylindrical or oval configuration, members 104 can be a triangular configuration, channels 104B can have a triangular configuration by with a cylindrical opening, and channels 104C can be a square like configuration. However, it is contemplated within the scope of the invention that any of channels 104 can have any shape or configuration, including but not limited to: ellipsoid, asymmetrical, or any polygon having three or more sides. Further, the tubes 104 and edging 100 can be a unitary one-piece construction mold or the tubes can be coupled, secured, or fastened to the interior portion of edging 100 via adhesives, fusion, rivets, bolts, screws, or any other fastening means. In one embodiment, the tubes 104, 106A-106B, and 107A-107B can be approximately four (4) to five (5) inches long having a ¼ to ⅜ inch outside diameter, 3/16 to 5/16 inch inside diameter, and 1/16-inch thickness, and wherein tubes 104, 106A-106B, and 107A-107B can be made of flexible or rigid PVC, PVC-C, or thermoplastic material. In addition, stakes or guides 120 can be approximately 9.5 to 11 inches long, 3/16-inch diameter, preferably 10 inches, and may have a slight hook or bend at one end or have a straight flat or nail head top, as shown in FIG. 2C. However, it is contemplated within the scope of the invention that the tubes or stakes may be of any length, width, thickness, dimension, or configuration. Further, FIGS. 3A-5B illustrates tubes 104-104C secure to the interior surface of edging 100 in one embodiment, whereas FIGS. 3B-5B illustrates tubes 104-104C disposed within edging 100 in another embodiment.

FIG. 6 illustrates a top aerial view of the edging apparatus 100 as assembled enclosing landscaping 210. In this embodiment, edging apparatus can be a unitary one-piece component wherein the ends 102A and 102B join, interlock, or dovetail together (see FIGS. 1-2). In other embodiments, edging apparatus 100 can be a plurality of units or apparatuses 100 coupled together in series to form an enclosed space or closed loop configuration, as shown in FIG. 14, or an un-enclosed space or open loop configuration, as shown in FIG. 15, wherein ends 102A and 102B can terminate and join each other, as shown in FIG. 15.

FIG. 7 illustrates one embodiment for packaging edging apparatus 100 of the present disclosure described herein. Here, flexible edging apparatus 100 can be rolled up in a tight manner and shrink-wrapped 300 in a vacuum sealed environment or placed within a container, bag, or receptacle. Alternatively, apparatus 100 can also be rolled in a spiral configuration and secured with one or more ties, strings, or closures. In addition, a plurality of edging apparatuses 100 may also be stacked on top of each other and packaged as two (2) to twenty (20) pieces and further shrink wrapped. In addition, stakes or guides 120 may also be shrink-wrapped 310 or placed within a container, bag, or receptacle. Alternatively, stakes or guides 120 may be fastened to apparatus 100 or its packaging 300, or alternatively placed within the packaging of apparatus 100. Here, packaged apparatus 100 can be displayed at a merchant or distributor location in a stacked configuration or may be provided as a bundle of two or more packaged apparatuses 100.

FIGS. 8 and 11 illustrate one embodiment for the exterior or outer surface portion of edging 100 illustrating a simulated stone, brick, or masonry surface texture. FIGS. 9 and 10 illustrate one embodiment for the interior or inside surface portion of edging 100, wherein the interior surface can be a smooth non-textured surface, or alternatively having a textured surface. In one embodiment, edging apparatus 100 can be manufactured via injection molding or spray up molding using any thermoplastic, polymer, polyurethane, or polyethylene derived material or resin. Further, the resin can include any additional fibers, composites, or coloring. In one embodiment, the edging apparatus 100 can be comprised of polyisocynate and amine resin material. Further, in one embodiment for a method of manufacture, a mold can be pre-created from existing or actual stone, masonry, or concrete wherein the surface texture of the stone or masonry is preserved in the mold. Next, a first layer of the resin or polymer material may be sprayed or poured within the mold to a pre-defined thickness and tubes or channels 104 are placed thereon. Next, a layer of rock gravel, grout, or sand-based material can be added to the mold or resin material. A final layer of the resin (or any other material) may be sprayed or poured onto the first layer and tubes 104, thereby securing the tubes 104 to the first layer, wherein the final edging apparatus 100 is formed. Next, the edging apparatus is dried and cured. The cured or dried edging apparatus 100 may then be removed from the mold, wherein the exterior surface (or any other surface) of the apparatus takes on the texture of the mold. It is contemplated within the scope of the invention that there may any number of layers of resin to form the edging apparatus 100. Here, the edging apparatus 100 can be durable, virtually indestructible, lightweight, flexible, and visually appealing by simulating actual stone, concrete, or masonry. Further the cured or dried apparatus 100 may also be cut or divided into several pieces via a blade, knife, scissors, laser, or the like. In addition, given the flexible nature of apparatus 100, a plurality of apparatuses 100 can be assembled and configured either in either a straight, curved, or asymmetric configuration, among others.

In another embodiment of for a method of manufacture and composition, a simulated stone composition for edging apparatus 100 can be manufactured via injection molding or spray up molding using any thermoplastic, polymer, polyurethane, or polyethylene derived material or resin. Further, the resin can include any additional fibers, composites, or coloring. In one embodiment, the composition can be comprised of polyisocynate, polyurethane, aliphatic, and amine resin material. Further, in one embodiment for a method of manufacture, a mold can be pre-created from existing or actual stone, masonry, or concrete wherein the surface texture and configuration of the stone or masonry is preserved in the mold. Next, a first layer of an oil-based substance or release agent can be sprayed into the mold. Further, a second layer of a rock gravel, grout-based substance, or sand substance may be disposed, dispensed, spread, or sprinkled out substantially uniformly within the mold and over the oil-based substance or first layer. Here, the oil-based substance or first layer can further allow the grout to be dispersed evenly or uniformly within the mold. Next, a third layer of the polyurethane resin or polymer material may be sprayed in to or poured within the mold to a pre-defined thickness, wherein the resin is sprayed or poured over the grout-based substance, thereby substantially enclosing the grout-based substance therein. Next, the composition is left for a predefined time to be cured. In this embodiment, the grout may comprise approximately 1% wt. up to and including 30% wt. of the final cured composition. In addition, the tint or color of the grout can determine the color of the polyurethane resin. Optionally, a fourth layer of the polyurethane resin (or any other material) may be sprayed or poured onto the third layer of the third resin, such as securing additional components to the third layer. Here, a grout or a grout-based substance is meant to indicate a composition, whether sanded or unsanded, such as pulverized stone or rock, clay, bentonite grout, cement based grout, sand based grout, polymer based grout, Acrylamide grout, N-Methylolacrylamide grout, acrylate grouts, polyurethanes grouts, hydrophilic grouts, hydrophobic grouts, ultrafine (or microfine) cement grout, epoxy grouts, archeological grout. In addition, the grout may also have any color or tint thereto.

Once the composition or apparatus 100 is cured or dried, the composition or apparatus 100 may then be removed from the mold, wherein the exterior surface (or any other surface) of the composition takes on the texture of the mold. It is contemplated within the scope of the invention that there may any number of layers of resin to form the composition. Here, the composition can be durable, virtually indestructible, lightweight, flexible, resistant to fading and discoloration, and visually appealing by simulating actual stone, concrete, masonry, wood, singles, or roofing material. Further the cured composition may also be cut or divided into several pieces via a blade, knife, scissors, laser, or the like. In addition, given the flexible nature of composition, a plurality of molded and cured compositions can be assembled and configured either in either a straight, curved, or asymmetric configuration, among others. For example, the cured composition may be used as edging for lawn and garden use, or as a roofing material.

In another embodiment for a method manufacture or composition, a simulated stone composition for edging apparatus 100 can be manufactured via injection molding or spray up molding using any thermoplastic, polymer, polyurethane, or polyethylene derived material or resin. Further, the resin can include any additional fibers, composites, or coloring. In this embodiment, the composition can be comprised of polyisocynate, polyurethane, aliphatic, and amine resin material. Further, a mold can be pre-created from existing or actual stone, masonry, or concrete wherein the surface texture and configuration of the stone or masonry is preserved in the mold. Next, spikes, tubes, or guide and stake receiving members are then placed uniformly or distributed evenly within the mold at pre-defined spacing intervals between each other. Next, a first layer of an oil-based substance, spray release agent, or non-stick formulation can be sprayed into the mold and tubes. Next, a layer of color or coloring agent is sprayed or disposed over the tubes and into the mold, wherein the coloring can represent any type of desired color for the exterior of the final cured and molded edging 100. Next, a first layer of polyurethane resin or polymer material may be sprayed onto the mold to a pre-defined thickness, wherein the resin or polymer materials is sprayed, dispensed, disposed, or poured over the tubes and color layer, preferably sprayed. Here, the polymer material layer can hold and/or push the color layer to the exterior region of the final cured and molded edging 100. Next, a layer of one or more of rock gravel, sand, or grout based substance can be added, disposed, dispensed, sprinkled, or spread uniformly within the mold and onto the previously sprayed polymer material layer. Here, the rock gravel or grout based substance can add further weight and volume to the final cured and molded edging product, and is also less expensive than using additional polymer material. Once, the rock gravel is dispensed, then a second layer of polyurethane or polymer material is sprayed, dispensed, disposed, or poured over the rock gravel and first polymer material layer, preferably poured. Here, the second layer of the polymer material may be of the same or similar composition or of different composition from the first polymer material layer, preferably similar composition. Here, the second layer of the polymer material can substantially or completely cover the tubes or spikes within it, such as shown in FIGS. 3B-5B. Next, the edging apparatus is left to cure into its molded configuration, wherein the curing time can take approximately one to three minutes. Next, the tubes and spikes may also be removed to reveal the aperture or holes within the edging apparatus 100, such that they allow guide or stakes 120 to be inserted therein. Next, the final cured edging apparatus 100 is removed from the mold and the edges of the removed edging apparatus are then trimmed, and the final trimmed edging apparatus 100 is prepared for packaging.

For example, in one sample experiment, a first composition of molded and cured edging apparatus 100 without the grout or rock was shown to fade and show signs of discoloration within about six days when exposed to direct sunlight. However, a second composition of molded and cured edging apparatus 100 with the grout or rock was shown to retain more than 90% or nearly 99.9% of its color after six days of exposure to direct sunlight. In addition, the additional layer of the grout, rock, or sand material can further add weight to apparatus 100 to provide better stabilization when installed or assembled, without a significant addition to cost.

It is contemplated within the scope of the invention that any other manufacturing method may also be used, including but not limited to: molding, blow molding, injection molding, extrusion molding, foam molding, laminating, and thermoforming, dip molding, rotational molding, thermoforming, laminating, foam, shrink fitting, shrink wrapping, end tube forming, forging, rolling, cold rolling, hot rolling, sheet metal rolling, impact extrusion, hemming, shearing, piercing, stamping, coining, ironing, flattening, swaging, spinning, peening, magnetic pulse, explosive forming, staking, flanging, hot metal gas forming, curling, machining, milling, turning, lathe, facing, boring, spinning, knurling, hard turning, drilling, reaming, countersinking, tapping, sawing, broaching, shaping, planning, honing, finishing, abrasive blasting, buffing, burnishing, electroplating, etching, plating, polishing, wire brushing, ultrasonic machining, electrical discharge, electron beam machining, electrochemical machining, chemical, laser cutting, grinding, gashing, adhesive bonding, epoxy bonding, thermoplastic bonding, polyurethane bonding, adhesive alloy bonding, riveting, nuts, bolts, screwing, nailing, pinning, stitching, stapling, press fitting, or three dimensional printing, or any combination thereof.

What is claimed is:

1. A method of manufacturing a landscape edging apparatus, comprising:
providing a mold having a simulated masonry or stone configuration;
positioning a plurality of tubular members onto the mold;
disposing an oil-based material into the mold;
disposing a first layer of a first polymer-based material into the mold;
disposing one or more of a rock, grout, or sand-based material into the mold; and
disposing a second layer of a second polymer-based material into the mold.

2. The method of claim 1, further comprising curing the first and second layers within the mold.

3. The method of claim 1, wherein the disposing the first layer further comprises spraying the first layer of the first polymer-based material into the mold.

4. The method of claim 1, wherein the disposing the second layer comprises pouring the second layer of the second polymer-based material into the mold.

5. The method of claim 1, wherein the first polymer-based material comprises a different composition from the second polymer-based material.

6. The method of claim 1, wherein the wherein the first polymer-based material comprises substantially the same composition of the second polymer-based material.

5. The method of claim 4, wherein the rock, grout, or sand-based material is evenly or uniformly distributed into the mold.

6. The method of claim 5, wherein the rock, grout, or sand-based material can further comprise 1% to 30% wt. of the landscaping edging apparatus.

7. The method of claim 1, further comprising dispensing color or a coloring agent into the mold.

8. The method of claim 1, wherein the second layer substantially or completely covers the tubular members.

9. A method of manufacturing a landscape edging apparatus, comprising:
providing a mold having a simulated masonry or stone texture;
dispersing a first material comprised of a first polymer or resin substance onto the mold;
dispersing a second material comprised of a grout-based substance onto the first layer;
placing one or more channel guide members onto the first material, wherein the receiving members adhere to the first material; and
dispersing a third material comprised of a second polymer or resin substance onto the mold.

10. The method of claim 9, further comprising curing the first, second, and third material.

11. The method of claim 10, wherein a duration for the curing can be from about one minute up to three minutes.

12. The method of claim 9, wherein the dispensing the first material further comprises spraying the first material of the polymer substance into the mold.

13. The method of claim 9, wherein the dispensing the second material comprises distributing the grout substantially evenly or uniformly over the first material.

14. The method of claim 9, further comprising dispensing an oil-based substance onto the mold.

15. The method of claim 9, further comprising dispensing a coloring agent onto the mold.

16. The method of claim 9, wherein the grout-based material is comprised of one or more of: pulverized stone or rock, clay, bentonite grout, cement based grout, sand based grout, polymer based grout, Acrylamide grout, N-Methylolacrylamide grout, acrylate grouts, polyurethanes grouts, hydrophilic grouts, hydrophobic grouts, ultrafine (or microfine) cement grout, epoxy grouts, and archeological grout.
